(19) United States
(12) Patent Application Publication
(10) Pub. No.: US 2004/0162890 A1
(43) Pub. Date: Aug. 19, 2004

(54) Imaging apparatus help system

(76) Inventor: Yasutoshi Ohta, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/779,652

(22) Filed: Feb. 18, 2004

(30) Foreign Application Priority Data
Feb. 18, 2003 (JP) 2003-039080
May 27, 2003 (JP) 2003-149506

(51) Int. Cl. G06F 15/16; G09G 5/00

(52) U.S. Cl. 709/218; 345/705

(57) ABSTRACT

An imaging apparatus help system includes an imaging apparatus having a display/input apparatus unit and an information storage unit, and a help server that are connected to a network. When a predetermined type of help is requested at the display/input apparatus unit, help data corresponding to the predetermined type of help are read from a cache memory of the information storage unit and displayed on a touch panel LCD. If the corresponding help data are not stored in the cache memory, a request for the corresponding help data is made to the help server so that the corresponding help data may be sent from the help server to be stored in the cache memory and displayed on the touch panel LCD. When the remaining storage capacity of the cache memory is reduced to no more than a predetermined capacity, the imaging apparatus deletes the help data stored in the cache memory according to a predetermined deletion rule. Further, the imaging apparatus help system may include a plurality of imaging apparatuses, and when a given imaging apparatus of the imaging apparatuses connected to the network requires a predetermined type of help data, an inquiry about an availability of the predetermined type of help data may be made to a device other than the given imaging apparatus that is connected to the network. In this way, help data may be efficiently provided.

### BACKGROUND OF THE INVENTION

1. Field of the Invention

The present invention relates to an imaging apparatus help system in which communication information such as help information can be efficiently and accurately provided.

2. Description of the Related Art

The functions of an imaging apparatus such as a copying apparatus, a printer apparatus, and a facsimile apparatus, for example, are becoming more and more sophisticated and complex so that operations to be executed by a user become increasingly complicated as well.

Under such circumstances, it is quite common for a user to get confused about the execution method of an operation.

In the past, a user could only refer to a paper manual to figure out how to perform an operation; however, in recent years and continuing, with frequent upgrades of the functions of an imaging apparatus and a growing trend towards paper conservation, a system in which help text can be directly provided on a display panel of the imaging apparatus is becoming widespread (this system being referred to as “electronic text help system” hereinafter). In the electronic text help system, a help manual is written in electronic text format and stored in a memory of the imaging apparatus as help data, and the help text may be displayed on the display panel of the imaging apparatus when the user calls for help.

However, in the electronic text help system, the limitations of the storage capacity of the imaging apparatus become a problem; that is, as the functions of the apparatus get more complicated, the volume of the help text data to be stored increases. If the imaging apparatus is arranged to have a storage area that can store all the help data, the cost of the imaging apparatus is significantly increased.

Alternatively, a portion of the help data may be stored in the imaging apparatus. However, help data that are likely to be referred to vary depending on the user environment, location, and usage of the imaging apparatus, and therefore, determining which portions of the help data to store in the imaging apparatus is very difficult. For example, even if the imaging apparatus were used in Japan, help data may still be needed in multiple languages. Due to such circumstances, selecting relevant help data and storing the selected help data in the imaging apparatus prior to its shipment from the factory is oftentimes impractical.

Also, with respect to facilitating understanding of an operation of the imaging apparatus, providing help merely through displaying electronic text is rather insufficient.

In response, in one prior art example, an operation guidance display apparatus that is implemented in an imaging apparatus is proposed. The operation guidance display apparatus is adapted to display a moving image together with image processing information on a display unit when the imaging apparatus detects a state in which a predetermined operation needs to be performed by a user, the moving image indicating the procedure for performing the operation and being stored as moving image data in a moving image data storage unit (refer to Japanese Patent No. 3274439).

In this prior art example, understanding of an operation of the imaging apparatus is facilitated by taking advantage of a panel display and providing help using moving image data.

In another prior art example, an imaging apparatus that handles display data described in a format compatible with the Internet environment is proposed. The display data in the format compatible with the Internet environment pertain to states occurring at the imaging apparatus, and are distinguished according to types of the states and/or their extent. The display data are stored in either a storage unit of the imaging apparatus or a storage unit provided over the Internet, and the imaging apparatus is adapted to determine the storage location of relevant display data based on the type and/or the extent of an occurring state, access the storage unit in the apparatus or the storage unit over the Internet to selectively read the relevant display data, and display the relevant display data on a user interface (refer to Japanese Laid-Open Patent No. 2002-016749).

In this prior art example, help data may be located over a network, and specific help data may be accessed and downloaded for display. In this way, detailed and easy-to-understand operation guidance information that is constantly updated may be provided without having to increase the memory capacity of the imaging apparatus, and also, by using a data caching technique, high speed access can be realized.

In a further prior art example, an operation guidance system is proposed in which system scenario data for guiding a user to perform appropriate operation procedures for running a program are provided. The scenario data for each function of the program are maintained in scenario maintaining means, and when a specific function is selected by scenario selection means, from the functions for which scenario data are maintained in the scenario maintaining means, an operation guiding means guides the user into performing the appropriate operations to run the program based on the scenario data corresponding to the selected function (refer to Japanese Laid-Open Patent No. 2002-073232).

In this prior art example, instead of providing help for the user to understand an operation method, a residing help program directly guides the user into executing an operation so that the operation can be further simplified for the user.

In another prior art example, a technique is disclosed for searching from a storage medium requested operation method information based on an analysis of operation manual request code received from a digital copying machine, and downloading the searched unique operation method information to the digital copying machine corresponding to the requestor (refer to Japanese Laid-Open Patent Publication No. 2001-312462).

However, in the prior art practices, improvements are demanded with respect to the storage capacity of the memory storing the help data and/or usage efficiency of the help system.

Specifically, in Japanese Patent No. 3274439 and Japanese Laid-Open Patent No. 2002-073232, a large memory storage capacity is required compared to a plain electronic text help system, and the imaging apparatus may be unable to store all the help data. Particularly, in Japanese Patent No. 3274439, where moving image data are used, although numerous compression formats have been proposed for compressing moving image data, the file size of a compressed file is still quite large and the required storage capacity may go over the limit of the memory storage capacity of the imaging apparatus. Also, a high-grade display panel that has good responsiveness and gray scale expressivity is desirable so that the moving image data can be displayed. This in turn raises the cost of the imaging apparatus.

In the case of Japanese Laid-Open Patent No. 2002-016749, the imaging apparatus may function quite effectively under a LAN environment; however, in this disclosure, a method of controlling data cacheing is not explained in detail, it being an incomplete technique.

Also, although the techniques disclosed in Japanese Laid-Open Patent Publication No. 2001-312462 and Japanese Laid-Open Patent No. 2002-016749 may be advantageous in a LAN environment, according to these disclosures, even when a plurality of imaging apparatuses reside within one network, each of the imaging apparatuses are designed to access the network individually. Thus, in a case where a plurality of imaging apparatuses of a same model or type are implemented in the network, the same help data may be individually downloaded by more than one imaging apparatus. This leads to unnecessary and wasteful consumption of network resources.

### SUMMARY OF THE INVENTION

The present invention has been conceived in response to one or more problems of the related art and its object is to provide an imaging apparatus help system and method in which communication information such as help information can be efficiently and accurately provided to an imaging apparatus.

It is another object of the present invention to provide an imaging apparatus help system and method in which help information accessed by one imaging apparatus may be shared by other apparatuses residing within the same network so that wasteful consumption of network resources can be avoided.

Specifically, an imaging apparatus help system according to an embodiment of the present invention includes:

an imaging apparatus that is connected to a network and is adapted to output and record an image on paper, the imaging apparatus including an operation unit, a display unit, and an information memory unit; and

an information server that is connected to the network and is adapted to receive a communication information request from the imaging apparatus, the information server including an information storage unit storing a plurality of types of communication information, wherein

when a user request for a predetermined type of the types of communication information is made at the operation unit of the imaging apparatus, if the predetermined type of communication information is stored in the information memory unit of the imaging apparatus, the imaging apparatus reads the predetermined type of communication information from the information memory unit and displays the read communication information on the display unit, and if the predetermined type of communication information is not stored in the information memory unit of the imaging apparatus, the imaging apparatus sends a request for the predetermined type of communication information to the information server, and the information server reads the predetermined type of communication information from the information storage unit and sends the predetermined type of communication information to the imaging apparatus, and the imaging apparatus stores the predetermined type of communication in the information memory unit and displays the predetermined type of communication information on the display unit; and

the imaging apparatus stores in the information memory unit one or more of the types of communication information received from the information server, and deletes at least a portion of the stored one or more types of communication information when a remaining storage capacity of the information memory unit is reduced to no more than a predetermined capacity.

According to the present invention, even when the storage capacity of the information memory unit of the imaging apparatus is small, desired communication information may be accurately provided and communication information that is once downloaded may be effectively used to accurately provide the desired communication information. In this way, an imaging apparatus help system in which communication information is efficiently provided at low cost may be realized.

An imaging apparatus help system according to another embodiment includes:

a plurality of imaging apparatuses and a help server that are connected to a network, wherein each of the imaging apparatuses and the help server has a storage unit for storing help data; and

help data operation means for realizing a help data operation when one of the imaging apparatuses connected to the network requires a predetermined type of help data, the help data operation being performed on at least one other device connected to the network.

According to the present invention, operations for help information may be performed on other devices within the network, and thereby, a network sharing online help system may be realized.

Also, an imaging apparatus help system according to another embodiment includes:

a plurality of imaging apparatuses and a help server that are connected to a network, wherein each of the imaging apparatuses and the help server has a storage unit for storing help data, and

inquiry means for making an inquiry about an availability of help data when one of the imaging apparatuses connected to the network requires a predetermined type of help data, the inquiry being made on at least one other device connected to the network.

According to the present invention, an availability of help information in the other devices within the network is checked before downloading the help information, and thereby, an even more efficient online help system may be realized.

Also, in a further embodiment of the present invention, a moving image object and/or audio data may be included as help data so that a user-friendly online help system may be realized.

Also, in a further embodiment of the present invention, help data stored in the devices connected to the network are compared to update old help data so that information within the online help system may be maintained up-to-date.

According to another embodiment of the present invention, a method of providing help information to an imaging apparatus that is connected to a help server via a network is provided, wherein the help server has a storage unit storing a plurality of types of help information, and the imaging apparatus has a memory unit for storing one or more of the types of communication information received from the help server, the method including:

searching for a predetermined type of the types of help information in the memory unit of the imaging apparatus;

requesting the help server to send the predetermined type of help information to the imaging apparatus when the predetermined type of help information is not found in the searching step;

sending the predetermined type of help information from the help server to the imaging apparatus and storing the predetermined type of help information in the memory unit; and

deleting at least a portion of the one or more types of communication information stored in the memory unit according to a predetermined rule when a remaining storage capacity of the memory unit is reduced to no more than a predetermined capacity.

According to another embodiment, a method of providing help data to an imaging apparatus that is connected to at least one other imaging apparatus and a help server via a network is provided, wherein the imaging apparatus, the other imaging apparatus and the help server each have a storage unit for storing one or more types of help data, the method including:

making an inquiry about an availability of a predetermined type of help data to the other apparatus; and

if the predetermined type of help data is available at the other imaging apparatus, reading and sending the predetermined type of help data from the other imaging apparatus to the imaging apparatus, and storing the predetermined type of help data in the imaging apparatus.

According to another embodiment, a method of providing help data to an imaging apparatus that is connected to a local help server, and a global help server via a network is provided, wherein the imaging apparatus, the local help server, and the global help server each have a storage unit for storing one or more types of help data, the method including:

making an inquiry about an availability of a predetermined type of help data to the local help server; and

if the predetermined type of help data is available at the local help server, reading and sending the predetermined type of help data from the local help server to the imaging apparatus, and storing the predetermined type of help data in the imaging apparatus.

### BRIEF DESCRIPTION OF THE DRAWINGS

FIG. 1 is a schematic diagram showing a configuration of an imaging apparatus help system according to an embodiment of the present invention;

FIG. 2 is a block diagram showing a configuration of a MFP shown in FIG. 1;

FIG. 3 is a plan view diagram showing exemplary display contents of a touch panel LCD of a display/input apparatus unit during normal operation of the MFP of FIG. 2;

FIG. 4 is a block diagram showing a configuration of a help server shown in FIG. 1;

FIG. 5 is a plan view diagram showing exemplary display contents of help information pertaining to a sort function that is displayed on the touch panel LCD of the MFP in an imaging apparatus help system conforming to a first embodiment of the present invention;

FIG. 6 is a diagram illustrating an operation in which the MFP sends a request for help data to the help server and the help server sends the requested help data to the MFP;

FIG. 7 is a plan view diagram showing exemplary display contents of help information pertaining to the sort function that is displayed on the touch panel LCD of the MFP in an imaging apparatus help system conforming to a second embodiment of the present invention;

FIG. 8 is a plan view diagram showing exemplary guidance display contents presented at the display/input apparatus unit in a case where guidance display is selected;

FIG. 9 is a plan view diagram illustrating an example of a selection screen for selecting a format of help to be provided, which selection screen is displayed on the touch panel LCD of the MFP in an imaging apparatus help system conforming to a third embodiment of the present invention;

FIG. 10 is a schematic diagram illustrating a configuration of an imaging apparatus help system according to a fourth embodiment of the present invention (where a local help server is not provided);

FIG. 11 is an operation flowchart illustrating operations of the imaging apparatus help system according to the fourth embodiment;

FIG. 12 is a diagram illustrating an operation of the imaging apparatus according to the fourth embodiment;

FIG. 13 is a diagram illustrating another operation of the imaging apparatus according to the fourth embodiment;

FIG. 14 is a diagram illustrating another operation of the imaging apparatus according to the fourth embodiment;

FIG. 15 is a diagram illustrating another operation of the imaging apparatus according to the fourth embodiment;

FIG. 16 is a schematic diagram illustrating a configuration of an imaging apparatus help system according to a fifth embodiment of the present invention;

FIG. 17 is an operation flowchart illustrating operations of the imaging apparatus help system according to the fifth embodiment of the present invention;

FIG. 18 is a diagram illustrating an operation of the imaging apparatus according to the fifth embodiment;

FIG. 19 is a diagram illustrating another operation of the imaging apparatus according to the fifth embodiment; and

FIG. 20 is a diagram illustrating another operation of the imaging apparatus according to the fifth embodiment.

### DESCRIPTION OF THE PREFERRED EMBODIMENTS

In the following, preferred embodiments of the present invention are described with reference to the accompanying drawings. It is noted that the following preferred embodiments correspond to exemplary applications of the present invention on which various limitations are imposed for the sake of technical advantages; however, the scope of the present invention is by no way limited to these examples unless specified in the claims.

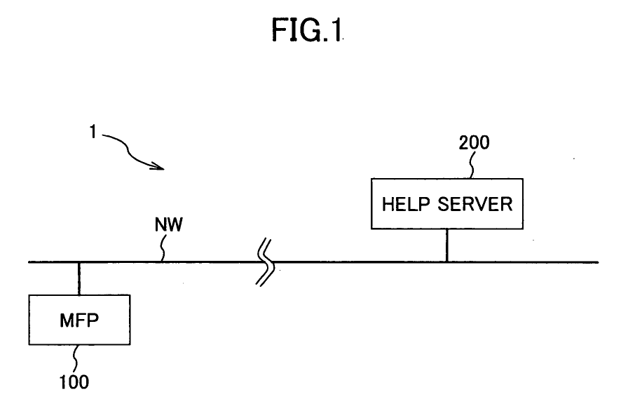

FIGS. 1˜6 represent an imaging apparatus help system according to a first embodiment of the present invention. FIG. 1 is a schematic diagram illustrating a configuration of the imaging apparatus help system according to the first embodiment.

The imaging apparatus help system 1 of the present embodiment as shown in FIG. 1 includes a MFP (multi function peripheral apparatus) 100 corresponding to an imaging apparatus and a help server (information server) 200 that are connected to a network NW such as a LAN (Local Area Network). The MFP 100 and the help server 200 are interconnected via a gateway.

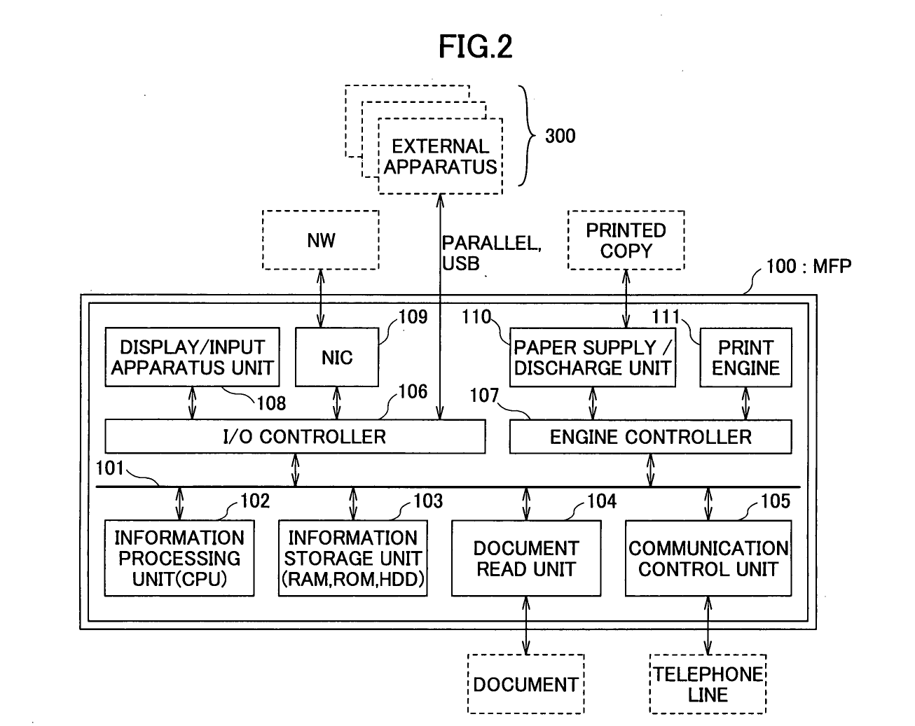

FIG. 2 is a diagram showing a configuration of the MFP 100. As is shown in this drawing, the MFP 100 includes a bus 101 to which an information processing unit 102, an information storage unit 103, a document read unit 104, a communication control unit 105, an I/O controller 106, and an engine controller 107, for example, may be connected to realize various functions such as a copying function, a printer function, a facsimile function (fax function), and a scanner function.

Further, a display/input apparatus unit 108, a NIC (Network Interface Card) 109, and external apparatuses 300 may be connected to the I/O controller 106, and a paper supply/discharge unit 110, and a print engine 111, for example, may be connected to the engine controller 107.

It is noted that there is no significant difference in hardware configurations between the MFP 100 used in the present embodiment and a conventional MFP apparatus. Characteristic features of the present embodiment such as a cache memory (corresponding to an information memory unit of the present invention) and a URL (Uniform Resource Locator) to the help server 200 are implemented in the information storage unit 103.

The information storage unit 103 may include, for example, include an OS (operating system); various control programs for realizing various processes such as copying, faxing, printing, and scanning; a PDL (page description language) processing system of the printer; a ROM (Read Only Memory) for storing information such as an initialization value of the system; a RAM (Random Access Memory) used as a working memory; a hard disk (HD); a flash memory; and a memory with battery backup or a memory that is developed over the hard disk corresponding to the cache memory. The operation control of the cache memory is preferably provided as an independent process operating over the OS. The cache memory stores help data as files. Help data that are not stored in the cache memory are requested to be sent from the help server 200, and the help data may be successively accumulated so long as there is enough room in the cache memory. When the cache memory becomes full (when the remaining capacity is reduced to no more than a predetermined capacity), unimportant cache data (help data stored in the cache memory) are automatically deleted so that new help data may be stored in the cache memory. The cache data deletion may be performed according to a predetermined deletion rule that may be based on, for example, the order of the receiving date (storage date) of the data (e.g., wherein data with an older date gets deleted first), usage frequency of the data (e.g., wherein data used less frequently are deleted first), and data size (e.g., wherein data with a smaller data size gets deleted first, or data with a larger data size gets deleted first). Since the help data are stored as files, their storage dates, and data sizes can be easily verified.

The hard disk of the information storage unit 103 may store basic programs of the MFP 100 and other various programs including the help programs as well as various data for executing the stored programs.

The information processing unit 102 may be made up of a CPU (Central Processing Unit), for example, which controls each component part of the MFP 100 based on the programs stored in the information storage unit 103 so as to perform basic processes of the MFP 100 as well as help processes that are described below. Particularly, it is noted that a cache control process performed in the help process is implemented as an independent process running on the OS.

The document read unit 104 may include a scanner system and an ADF (Auto Document Feeder), for example, and may be arranged to read at a predetermined resolution an image of a document carried from the ADF to a read position of the scanner system.

The communication control unit 105 may include a modular jack and a NCU, for example, and may be connected to a telephone line so that it may realize program communication control through executing an automatic call process, a call receiving process, and a modulation/demodulation process via the telephone line.

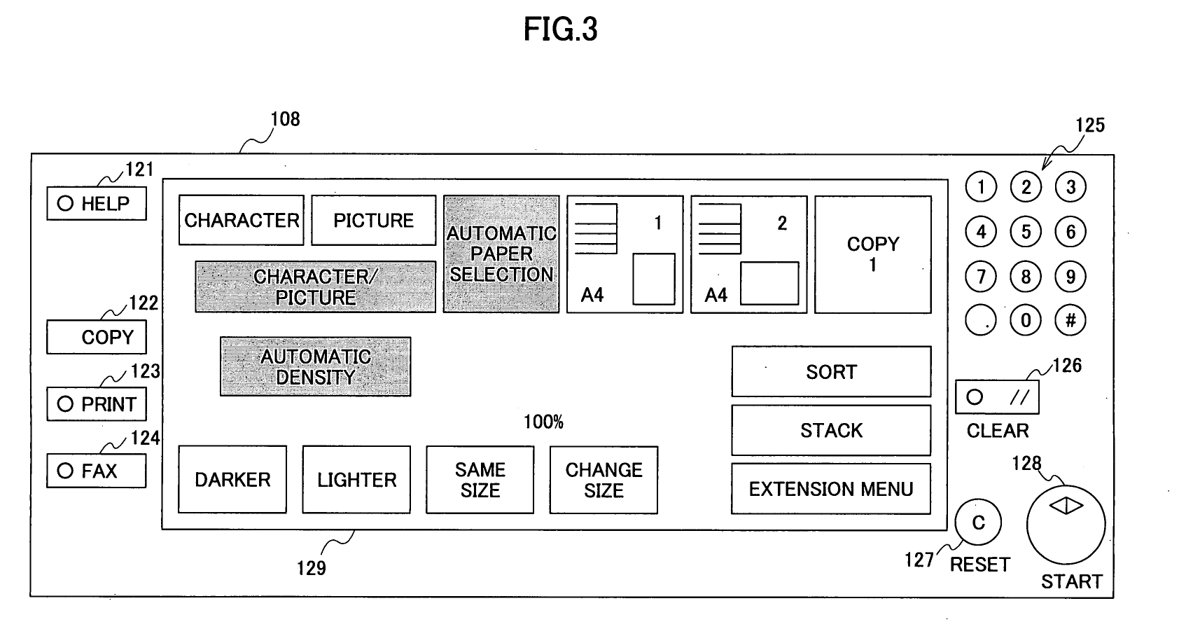

FIG. 3 shows an exemplary configuration of the display/input apparatus unit 108. As is shown in this drawing, the display/input apparatus unit 108 may include a help key 121, a copy key 122, a printer key 123, a fax key 124, decadal system keys 125, a clear key 126, a reset key 127, a start key 128, and a touch panel LCD (Liquid Crystal Display) 129. On the touch panel LCD 129, key buttons other than the keys mentioned above that are still required in performing an operation of the MFP 100 may be displayed, and also, information being communicated to the user from the MFP 100 (communication information) such as help information may be displayed. The example of FIG. 3 shows a state in which a copy mode is selected by the copy key, and an automatic paper selection mode, a character/picture mode, and an automatic density mode are selected by the key buttons displayed on the touch panel LCD 129.

Referring back to FIG. 2, the NIC 109 is connected to the network NW and is arranged to establish communication with other apparatuses on the network, particularly the help server 200.

The I/O controller 106 is arranged to exchange information with the display/input apparatus 108, the NIC 109, and the external apparatuses 300.

The print engine 111 operates under the control of the engine controller 107 and is arranged to output and record an image onto paper based on image data according to a predetermined printing method such as ink jet printing, or electrophotography printing.

The paper supply/discharge unit 110 operates under the control of the engine controller 107, and is arranged to carry a sheet of paper to a printing position of the print engine 111, and discharge the printed sheet as a print copy.

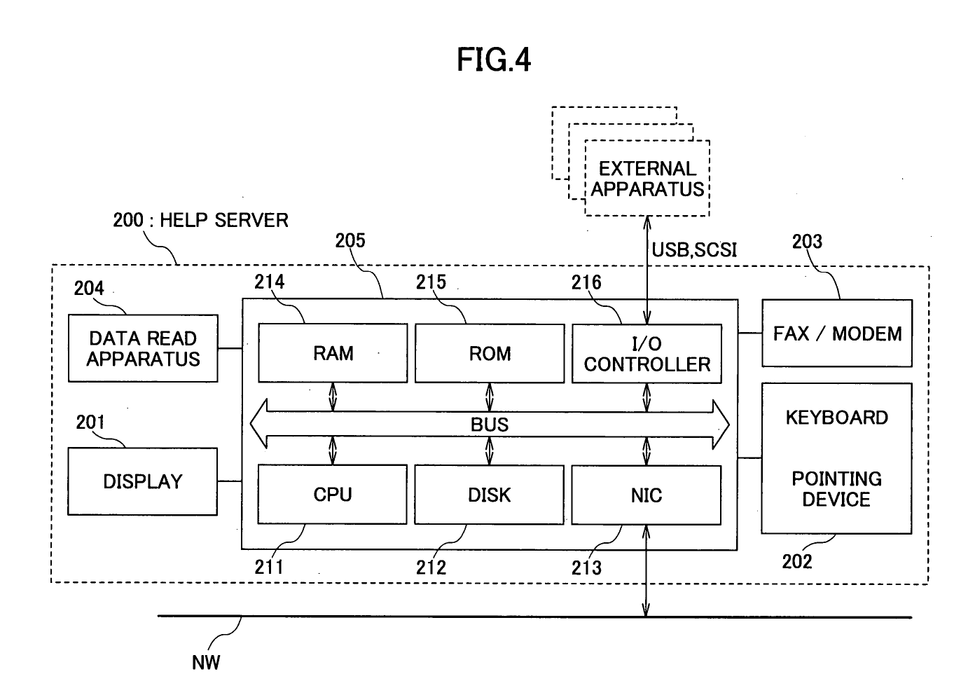

FIG. 4 is a diagram showing an exemplary configuration of the help server 200. The help server 200 may correspond to a computer that has a display 201, an input unit 202 such as a key board and a pointing device, a fax modem 203, a data read apparatus 204 such as a FDD, and a computational processing apparatus 205, for example.

The computational processing apparatus 205 may include a CPU 211 that is capable of executing various commands, a DISK 212 corresponding to a large capacity storage unit, a NIC (Network Interface Card) 213 that establishes communications with apparatuses within the network, a RAM 214, a ROM 215, and an I/O controller 216 (e.g., implementing a USB and SCSI port), for example, wherein each of these component parts are connected to a bus 217.

The I/O controller 216 is connected to external apparatuses to exchange information with the external apparatuses.

The DISK 212 corresponds to a large capacity storage unit such as a fixed disk and may be arranged to store an OS, a help data program, and a web server program, for example. The OS implemented in the DISK 212 may be any type of OS, and the web server program may also be a general-purpose program such as Apache.

The DISK 212 (corresponding to an information storage unit of the present invention) may store text data (e.g., English text data) included in the help data in html format, for example, and may store image data included in the help data in jpg format, for example.

The help server 200 reads communication related processing programs such as the web server program when the OS is started and operates these programs in the background. Upon receiving a request from the MFP 100, the help server 200 sends help information that is requested by the MFP 100.

In the imaging apparatus help system 1 made up of the MFP 100 and the help server 200, one help server apparatus 200 may be arranged to support a plurality of MFPs 100 of various types as long as the amount of data to be stored does not exceed the storage capacity of the DISK 212 and the amount of traffic to the help server 200 can be maintained below a predetermined limit. On the other hand, a plurality of help servers 200 may be arranged to provide help data for one type of MFP 100 within the network NW in order to reduce the load of a single help server 200.

Also, since the web server program automatically writes out an access log, the help server 200 may use this to identify a help item (type of help) that is accessed relatively often and associate the corresponding operation of this help item as an operation that has a high probability of confusing the user. Based on such information, a highly accessed help item may be stored in the MFP 100, for example. Also, the MFP user interface designer may refer to this information upon considering product improvement.

In the following, the effects of the present embodiment are described. In the imaging apparatus help system 1 of the present embodiment, the user may press the help key 121 of the display/input apparatus 108 upon getting confused about an operation of the MFP 100. In turn, help information may be displayed on the touch panel LCD 129 based on help data read from the cache memory of the information storage unit 103 or downloaded from the help server 200.

In the following, an exemplary case in which the user is confused about a sort function is described. In this case, the user may press the help key 121 of the display/input apparatus 108 shown in FIG. 3, and touch a sort button displayed on the touch panel LCD 129.

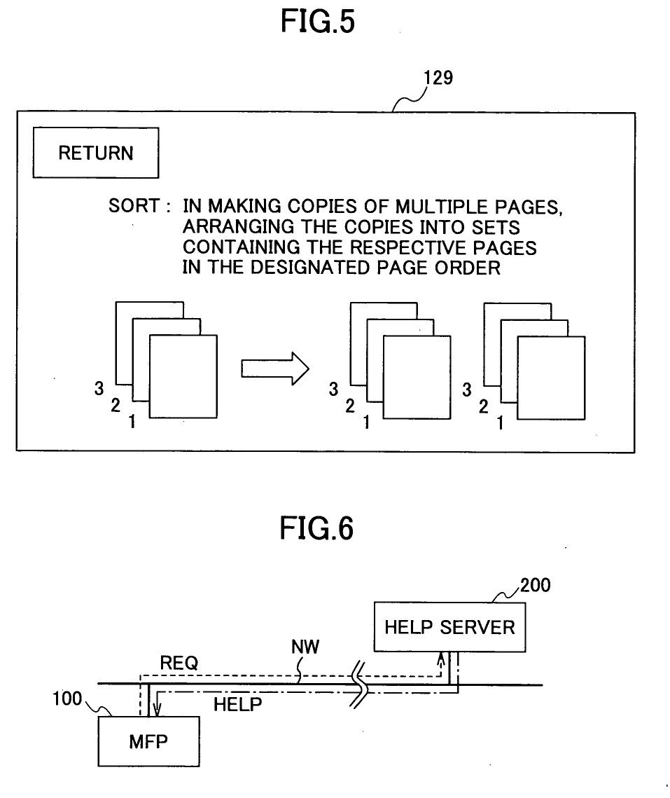

When the help key 121 is pressed and the sort button is touched, the MFP 100 searches the cache memory for help data pertaining to the sort function. When help data pertaining to the sort function are found in the cache memory, the MFP 100 reads the help data and displays the help information on the touch panel LCD 129 of the display/input apparatus 108 as is shown in FIG. 5.

In a case where help data pertaining to the sort function are not found upon searching the cache memory, a URL (Uniform Resource Locator) for the help data pertaining to the sort function may be read from the information storage unit 103, and the MFP 100 may access the help server 200 using this URL, as is illustrated by a dotted line indicated as “Req” in FIG. 6.

When a request for help data pertaining to the sort function is received from the MFP 100, the help server 200 may read the requested help data pertaining to the sort function from the DISK 212, and send the requested help data to the MFP 100 as is illustrated by a dot-dash line indicated as “Help” in FIG. 6. The help server 200 may, for example, use http as a communication protocol in sending the help data, and may send text data included in the help data in html format and image data included in the help data in jpg format.

Upon receiving the requested help data from the help server 200, the MFP 100 displays the corresponding help information on the touch panel LCD 129 of the display/input apparatus 108 as is shown in FIG. 5, and also stores the received help data in its cache memory. Also, when the help data from the help server 200 are sent in html format and jpg format, the MFP 100 is able to display the help data oh the touch panel LCD 129 as help information using a browser.

FIG. 5 illustrates an example in which the help information is displayed in English text with an image file (one object).

When the cache memory of the information storage unit 103 becomes full (e.g., when the remaining storage capacity of the cache memory is reduced to no more than a predetermined capacity), the MFP 100 deletes help data that are stored therein according to a predetermined deletion rule. For example, help data may be deleted according to a storage date order (e.g., wherein data stored at an earlier date are deleted first), a usage frequency order (e.g., wherein help data that are less frequently used are deleted first), or a data size order (e.g., wherein smaller-sized help data are deleted first, or wherein larger-sized help data are deleted first).

Accordingly, in the imaging apparatus help system 1 of the present embodiment, the MFP 100 that is connected to the network NW and is adapted to record an image on paper has a cache memory implemented in its information storage unit 103 for storing communication information that is to be provided to a user, and when an information request for a specific type of information is made at the display/input apparatus 108, the MFP 100 reads the communication information corresponding to the specific type of information from the information storage unit 103 and displays the read out information on the touch panel LDC 129 of the display/input apparatus 108 to provide the requested information to the user. When the communication information corresponding to the requested information cannot be found in the cache memory of the information storage unit 103, a request for the corresponding communication information is made to the help server 200 that is also connected to the network NW. Upon receiving the requested communication information from the help server 200, the MFP 100 stores the communication information in its cache memory in the information storage unit 103 and displays the information on the touch panel LCD 129. Herein, when the remaining storage capacity of the cache memory of the information storage unit 103 is no more than a predetermined capacity, deletion of communication information stored in the cache memory is performed.

In this arrangement, even when the storage capacity of the cache memory in the information storage unit 103 of the MFP 100 is small, desired communication information may be accurately provided, and communication information that is once downloaded can be effectively used to provide the desired communication information. Accordingly, communication information may be efficiently provided at low cost.

It is noted that in the imaging apparatus help system 1 of the present embodiment, help information (help data) for the operation of the MFP 100 may be handled as communication information.

Thus, even when the storage capacity of the cache memory in the information storage unit 103 of the MFP 100 is small, desired help information may be accurately provided, and help information that is once downloaded can be effectively used to provide the desired help information. Accordingly, help information may be efficiently provided at low cost.

It is also noted that in the imaging apparatus help system 1 of the present embodiment, the deletion of the communication information from the cache memory of the information storage unit 103 may be performed according to the storage date order wherein communication information stored earlier is deleted first.

Thus, the communication information may be efficiently managed, and the cache memory having a small storage capacity may be effectively used so that communication information may be efficiently provided at low cost.

It is further noted that in the imaging apparatus help system 1 of the present embodiment, the deletion of the communication information from the cache memory of the information storage unit 103 may be performed according to the usage frequency order wherein communication information that is used less often is deleted first.

Thus, the communication information may be managed even more efficiently and the cache memory may be used even more effectively so that communication information may be provided more efficiently at low cost.

It is further noted that in the help system 1 of the present invention, the deletion of the communication information may be performed according to the data size order. Thus, cache control of online communication information may be realized more efficiently and the cache memory with a small storage capacity may be used more effectively so that the communication information may be provided more efficiently at a low cost.

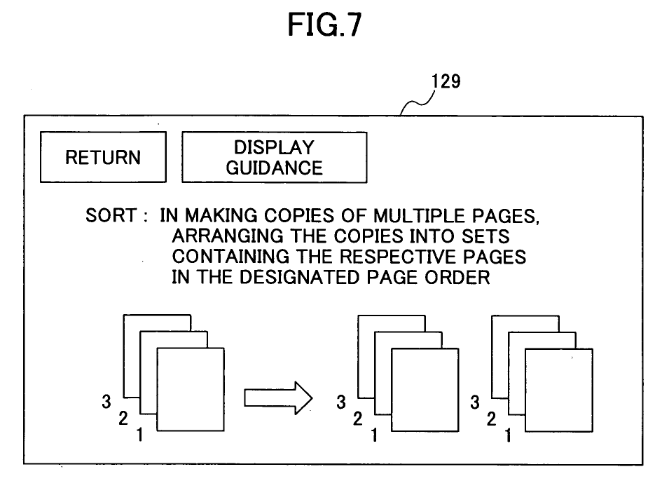

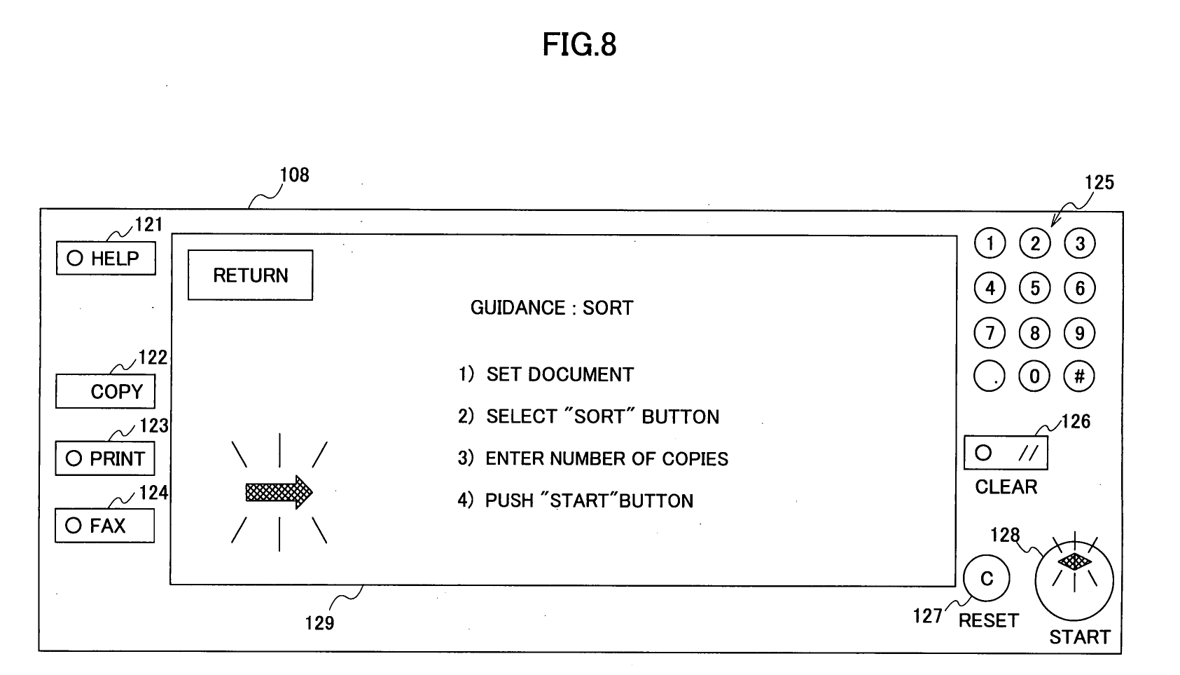

FIGS. 7 and 8 illustrate an imaging apparatus help system according to a second embodiment of the present invention.

It is noted that the present embodiment is applied to an imaging apparatus help system configuration that is identical to that of the imaging apparatus help system 1 of the first embodiment. Thus, in the description of the present embodiment, component parts that are identical to those of the imaging apparatus help system 1 are assigned the same numerical references.

In the imaging apparatus help system 2 according to the present embodiment, operation guidance is performed using a program as well as text information and image information (image object).

Thus, in the imaging apparatus help system 2 of the present embodiment, the cache memory of the MFP 100 and the DISK 212 of the help server 200 store programs for performing operation guidance as well as text data and image data as help data.

As for the program, a JAVA applet or a mobile agent that can be executed at the MFP 100 may be used, for example. The Java applet corresponds to a program that is used for describing an object having movement within the browser, and since this is merely a program, it has an advantage of having a small data size compared to a moving image data file; however, the movement is confined to be within the browser. The mobile agent corresponds to a type of remote program scheme, and may also be simply referred to as an agent program or a software agent. The mobile agent has more flexibility as a program compared to the JAVA applet, and is capable of operating outside the browser, that is, it is able to directly operate within the internal system of the MFP 100.

When the MFP 100 reads help data corresponding to the requested help from the cache memory, it may also read programs such as the JAVA applet or the mobile agent corresponding to the requested help. Alternatively, the MFP 100 may download the JAVA applet or the mobile agent corresponding to the requested help upon downloading the help data corresponding to the requested help from the help server 200. Then, the help information corresponding to the read out help data or the downloaded help data may be displayed on the touch panel LCD 129. Herein, the MFP 100 may display, for example, a touch button that is indicated as “display guidance” as is shown in FIG. 7. The user may touch this touch button upon requesting guidance. This guidance presents the actual procedures for performing an operation to the user by displaying moving objects and blinking buttons, for example.

When the touch button for requesting the display of guidance is touched, the MFP 100 executes the program read out from the cache memory together with the help data or the program downloaded from the help server together with the help data, and may display, for example, a moving object or a blinking button to provide guidance pertaining to the actual procedures of performing an operation as is shown in FIG. 8.

In the example of FIG. 8, a sorting guidance is displayed where items 1 through 4 are provided as help text information, and a blinking arrow (which is positioned at item 4 in FIG. 8) is arranged to move from items 1 through 4. FIG. 8 shows a state in which the start button 128 is also blinking in order to indicate the button (key) that is to be operated.

In such case, a program such as the mobile agent administers the start button 128 to blink. That is, the program directly operates on an API (Application Program Interface) for controlling the buttons provided in the MFP 100 to administer the start button 128 to blink. Similar guidance may be provided for the items 1 to 3 as well; that is, the corresponding button (key), lamp, or mobile component for each of the items may be activated so as to visually guide the user into executing an operation.

It is noted that the program for performing the operation guidance may be read out from the cache memory or downloaded from the help server together with the help data as described above, or alternatively, the help data may be read out or downloaded on its own.

As is described above, in the imaging apparatus help system 2 of the present embodiment, the communication information (help data) includes a program that is executable by the MFP 100.

Thus, for example, a simulation of an operation of the MFP 100 can be realized by the program to further facilitate understanding of the communication information (help data) so that useful communication information (help data) may be efficiently provided.

Also, in the imaging apparatus help system 2 of the present embodiment, a JAVA applet may be used as the program for providing operation guidance.

Thus, the cache memory in the information storage unit 103 may be prevented from being overloaded, and the acquisition of communication information online may be realized in a short period of time so that providing comprehensive communication information may be facilitated. Thereby, useful communication information may be efficiently provided.

Further, in the imaging apparatus help system 2 of the present embodiment, a mobile agent may be used as the program for providing operation guidance.

Thus, the cache memory in the information storage unit 103 may be prevented from being overloaded, and the acquisition of communication information online may be realized in a short period of time so that providing comprehensive communication information may be facilitated. Thereby, useful communication information may be efficiently provided.

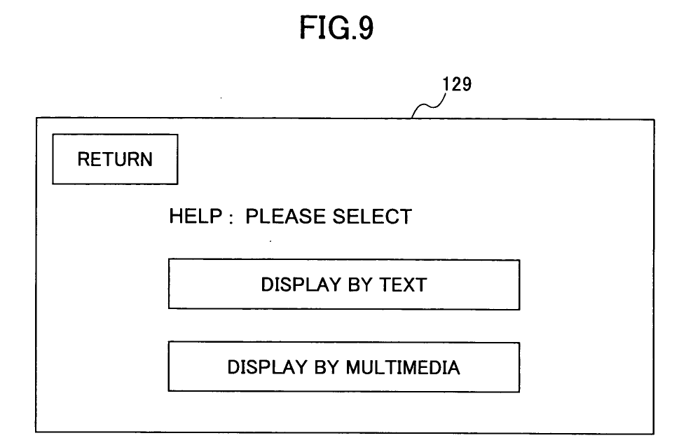

FIG. 9 illustrates an imaging apparatus help system according to a third embodiment of the present invention.

It is noted that the present embodiment is applied to an imaging apparatus help system configuration that is identical to that of the imaging apparatus help system 1 according to the first embodiment, and thus, in the following description of the present embodiment, the same numerical references are used for component parts that are identical to the first embodiment.

In the imaging apparatus help system 3 of the present embodiment, a program is used for operation guidance as well as text information and image information (image object) for providing help information. However, in the present embodiment, the user is made to select a help format.

When the help key 121 is pressed, the MFP 100 displays a help selection screen for selecting a help format on the touch panel LCD 129 of the display/input apparatus 108 as is shown in FIG. 9. The help selection screen may provide, for example, the choices of help displayed in text format or help displayed in multimedia format as in the example of FIG. 9. Displaying help in text format corresponds to displaying help information using text and image files (object) as in the first embodiment of the present invention, and displaying help in multimedia format corresponds to displaying help information with operation guidance by means of a program as in the second embodiment of the present invention.

When the button for selecting the help display in text format or the button for selecting the help display in multimedia format displayed on the touch panel LCD 129 is touched, and a help format is selected, the MFP 100 reads the corresponding help data in the selected help format from the cache memory (i.e., in the case of help by multimedia, the corresponding help program is sought as well), or alternatively, the help data (and possibly the help program) may be downloaded from the help server 200. The help data are then displayed on the touch panel LCD 129 as help information, and in the case of displaying help through multimedia, operation guidance is also provided.

As is described above, in the imaging apparatus help system 3 of the present embodiment, communication information in a plurality of formats are prepared for one specific type of request for communication information. Thus, when a format of communication information is selected for a communication information request made at the display/input apparatus unit 108, the MFP 100 may read the communication information in the designated format from the cache memory of the information storage unit 108 to provide the communication information in the designated format. Alternatively, the MFP 100 may make a request for the communication information in the designated format to the help server 200, and upon receiving the requested communication in the designated format, the MFP 100 may store the communication information from the help server 200 in its cache memory and present the communication information for display.

In this way, communication information in a format suiting the needs or desires of the user may be provided so that useful communication information may be provided more efficiently.

Also, in the imaging apparatus help system 3 of the present embodiment, communication information in one format may include a program that is executable in the MFP 100.

Thus, communication information in a format conforming to the needs or desires of the user may be provided so that useful communication information may be efficiently provided. Specifically, when the network bandwidth is narrow, or when the network traffic is large, the user may select the text display whereas in a reverse situation, the user may select the multimedia display. In this way, the user may select the optimum help display format according to the environmental conditions of the system.

It is noted that in the above description of the present embodiment, text, images, and programs are mentioned as exemplary formats of help data corresponding to communication information; however, the present invention is not limited to the above examples, and help data in different languages may be provided as different formats of help data, for example. Specifically, help data corresponding to help in a plurality of languages (e.g., Japanese, English, and German) may be stored, and the user may be able to select a language in which the help data are to be presented. In such case, font data for displaying help data in the respective languages, and a language switching screen may be provided, and when a user switches the language setting, the MFP 100 may read the help data in the corresponding language from the cache memory or make a request for the help data to the help server 200 so that desired help data may be easily provided.

In such an arrangement, by providing communication information (help data) in a plurality of languages, the help system may be able to assist a wider range of users, and thus, useful communication information may be efficiently provided.

Also, in the above-described preferred embodiments of the present invention, help is provided by outputting visual information; however, the present invention is not limited to these examples, and a method of providing help may involve, for example, outputting audio information or a combination of audio information and visual information in a case where multimedia help is selected.

In this case, a speaker, an amp, and an audio D/A converter, for example, may be implemented in the MFP 100, and compressed audio data may be provided as help data.

Next, an imaging apparatus help system according to a fourth embodiment of the present invention is described.

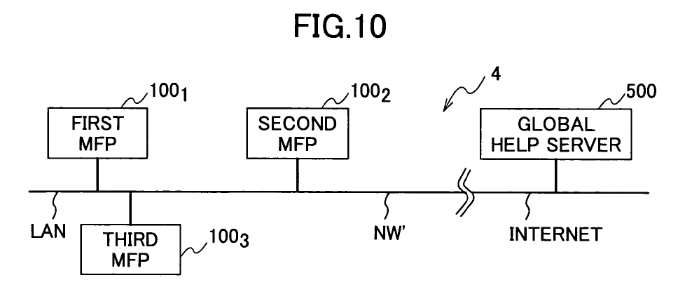

FIG. 10 is a schematic diagram illustrating an exemplary configuration of the imaging apparatus help system according to the fourth embodiment (where a local help server is not provided).

As is illustrated in FIG. 10, the imaging apparatus help system 4 of the present embodiment includes a plurality of MFPs (i.e., first MFP 100₁, second MFP 100₂, and third MFP 100₃, collectively referred to as ‘MFP 100’ hereinafter) and a help server 500 that are connected to a network NW′ such as a LAN and the Internet. In this example, the MFP 100 resides within the LAN, and the help server 500 is located over the Internet, and these apparatuses are interconnected via a gateway.

In the following, in order to make a distinction between a help server provided over the Internet and a help server residing within a LAN, the former is referred to as a ‘global help server’ and the latter is referred to as ‘local help server’. The help server 500 used in the present embodiment corresponds to a global help server, and a help server 700 described below corresponds to a local help server. It is noted that the global help server 500 and the local help server 700 both correspond to a computer, and the difference between the two apparatuses lies in the network to which they are connected. The configurations of the global help server 500 and the local help server 700 may be identical to that of the local help server 200, which is illustrated in FIG. 4.

In the following, the operations of the imaging apparatus help system 4 shown in FIG. 10 are described.

In the conventional art, when help is desired in a MFP, the MFP checks to see whether the desired help data are stored within its own apparatus, and if the help data cannot be found, the MFP immediately accesses a global help server. In such case, a pointer (e.g., URL) for a specific type of help is read from within the MFP, and using this URL, the MFP accesses the global help server, receives the corresponding help data from the help server, and displays this help data on its display panel, for example.

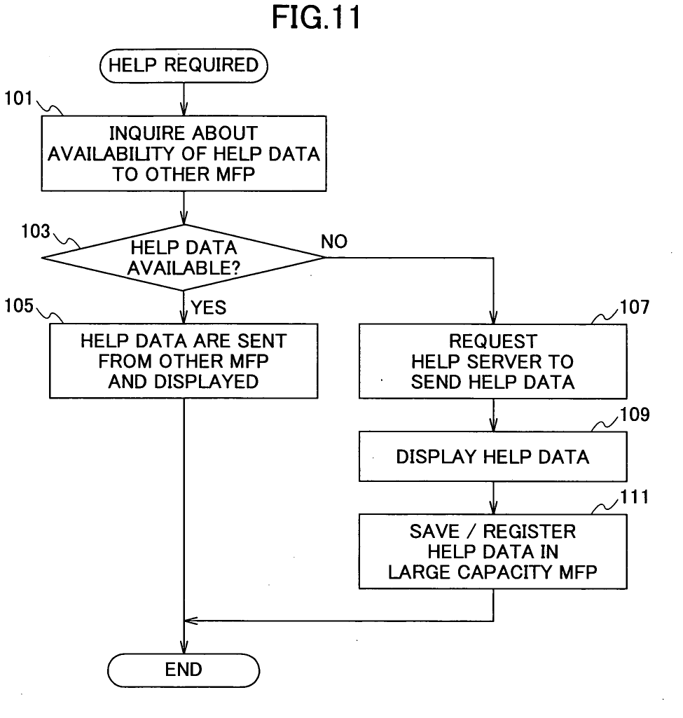

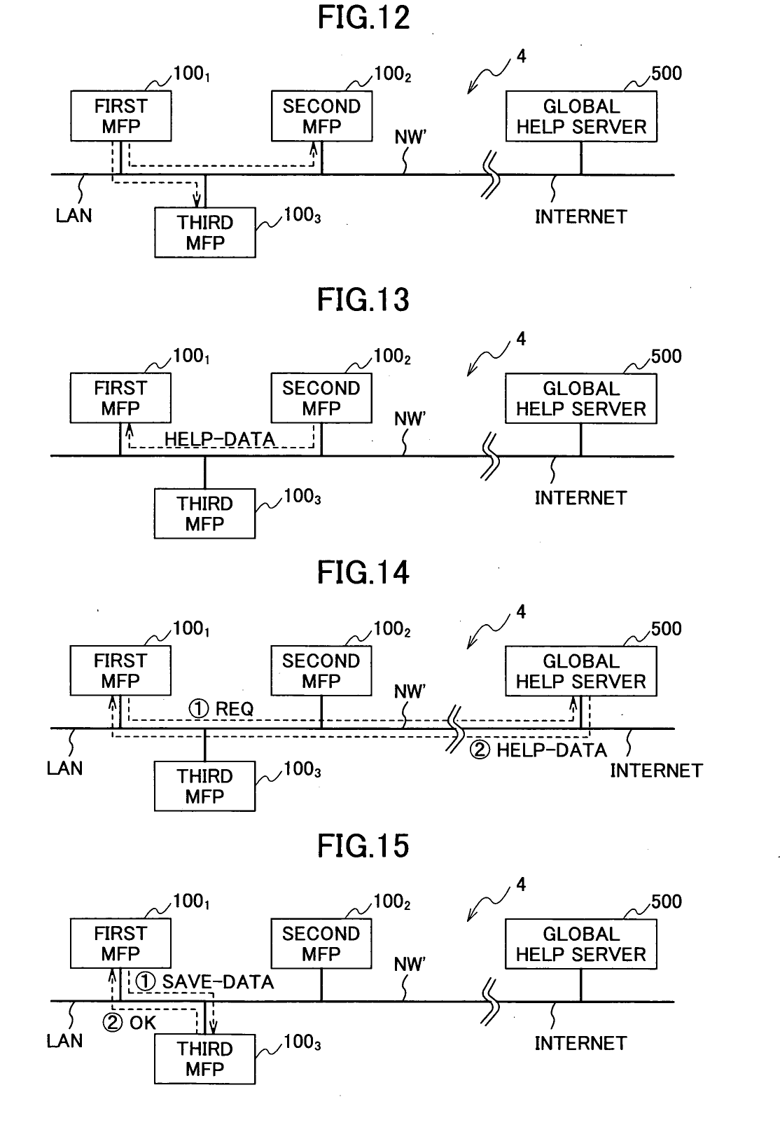

In the imaging apparatus help system 4 of the present embodiment shown in FIG. 10, a cooperative help system is established in a manner described below. The cooperative help system is described using an operation flow chart shown in FIG. 11 and the diagrams of FIGS. 12˜15 illustrating operations of the help system 4.

First, referring to FIG. 12, when help is desired in the first MFP 100₁, the first MFP 100₁ makes inquiries to other MFPs 100 residing within the LAN (i.e., second MFP 100₂ and third MFP 100₃) to see whether the desired help is available (corresponding to steps 101 and 103 in FIG. 11). For example, in a case where the corresponding help data for the desired help are stored in the cache memory of the second MFP 100₂, the corresponding help data may be sent from the second MFP 100₂ to the first MFP 100₁ as is shown in FIG. 13, and the help information may be displayed at the first MFP 100₁ (corresponding to step 105 of FIG. 11).

When the corresponding help data are not available within the LAN, the first MFP 100₁ may request the global help server 500 located over the Internet to send the corresponding help data, after which it receives the requested help data, as is shown in FIG. 14 (step 107 of FIG. 11), and displays the desired help information (step 109 of FIG. 11).

As help data are taken in from outside the LAN, the size of the cache data (help data stored in the MFP 100) gets larger. In such case, deletion of cache data may be performed starting with older data, for example, or alternatively, if a MFP 100 having a large capacity storage unit such as a hard disk HD (referred to as ‘large capacity MFP’ hereinafter) is provided within the LAN, the help data may be integrally managed at this large capacity MFP instead of accumulating cache data in each individual MFP 100. In the following description of the present embodiment, for the sake of convenience, it is assumed that the third MFP 100₃ corresponds to the large capacity MFP.

In this case, for example, after displaying the help data, the first MFP 100₁, may request the third MFP 100₃ to save and register the help data, as is shown in FIG. 15, and when the registration is successfully completed, the first MFP 100₁ may delete its corresponding cache data (step 111 of FIG. 11). In this way, the storage area of the large capacity MFP may be effectively shared by a plurality of MFP apparatuses, and the cache area of each of the MFP apparatuses may be reduced.

According to the above description, the cached help data are left untouched until the cache area runs out; however, in other arrangements, the cached help data may be rewritten more promptly. For example, a random time once a month may be set in each MFP 100, and at the set time, the MFP 100 may make an inquiry to the global help server 500 to compare its cached help data with the corresponding help data stored in the global help sever 500. If it is determined that the cached help data are old (i.e., the corresponding help data stored in the global help server 500 are updated), the cached data are updated accordingly by downloading the new help data from the help server 500. In such an arrangement, the cached help data may be automatically updated when a newer version of the corresponding help data is provided, and thus, the cached help data in the MFP 100 may be maintained up-to-date. Also, since the downloading request for updated help data is made by the MFP 100 side within the LAN, this operation may be realized even when a firewall is implemented.

It is noted that help data used in the present embodiment is not limited to a certain language, and also, the help data is not limited to text data. For example, moving image data in GIF format, or a moving image object represented using JAVA (registered trademark) applet may be included. Further, audio data may be used along with image and text data, for example. In such case, since a conventional MFP is not adapted to output audio data, additional devices such as a speaker, an amp, and an audio D/A converter may be implemented, as described above, and the help server 500 may store compressed audio data as help data.

Also, in the present embodiment, the communication protocol used for establishing communication between the apparatuses residing within the LAN is not limited to a certain type of communication protocol. For example, a unique protocol may be used, or an existing protocol such as UPnP and JINI may be used.

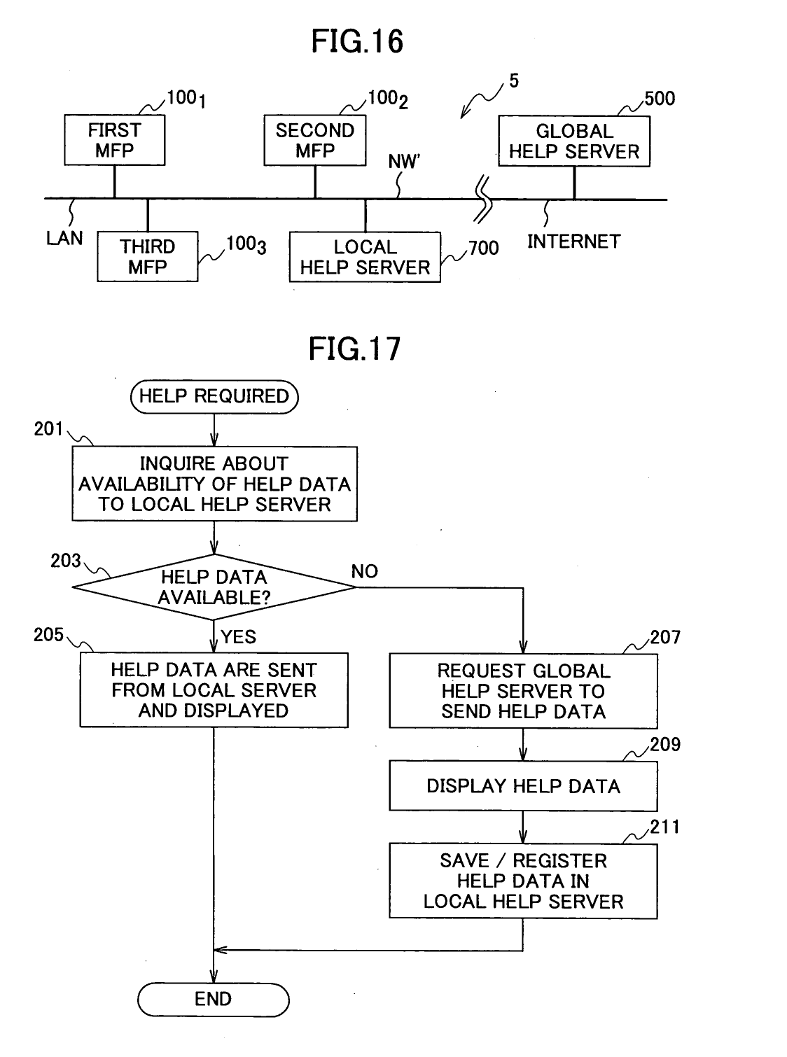

FIG. 16 is a diagram illustrating an imaging apparatus system according to a fifth embodiment of the present invention (wherein a local help server is provided). The difference between the fourth embodiment and the fifth embodiment lies in the fact that a local help server 700 is implemented within the LAN. Other features of the imaging apparatus help system 5 according to the present embodiment are identical to those of the imaging apparatus help system 4.

As is shown in FIG. 16, the imaging apparatus help system 5 of the present embodiment includes a plurality of MFPs (imaging apparatuses) 100, a local help server 700, and a global help server 500 that are interconnected via a network NW′ such as a LAN and the Internet. It is noted that the MFP 100 and the local help server 700 are implemented within the LAN, and the global help server 500 is implemented over the Internet. Further, the MFP 100, the local help server 700, and the global help server 500 are interconnected via a gateway.

The local help server 700 has the function of providing help data to the MFP 100 residing within the LAN in place of the global help server 500.

In the following, operations of a cooperative help system according to the present embodiment (imaging apparatus help system 5) is described with reference to an operation flowchart shown in FIG. 17 and diagrams of FIGS. 18˜20 illustrating exemplary operations of the system.

First, referring to FIG. 18, when help is desired in the first MFP 100₁, the first MFP 100₁ makes an inquiry to the local help server 700 to see whether the corresponding help data is available using a pointer (steps 201 and 203 of FIG. 17). If the corresponding help data is cached in the local help server 700, the corresponding help data may be sent from the local help server 700 to the first MFP 100₁ so that the desired help information may be displayed at the first MFP 100₁ (step 205 of FIG. 17).

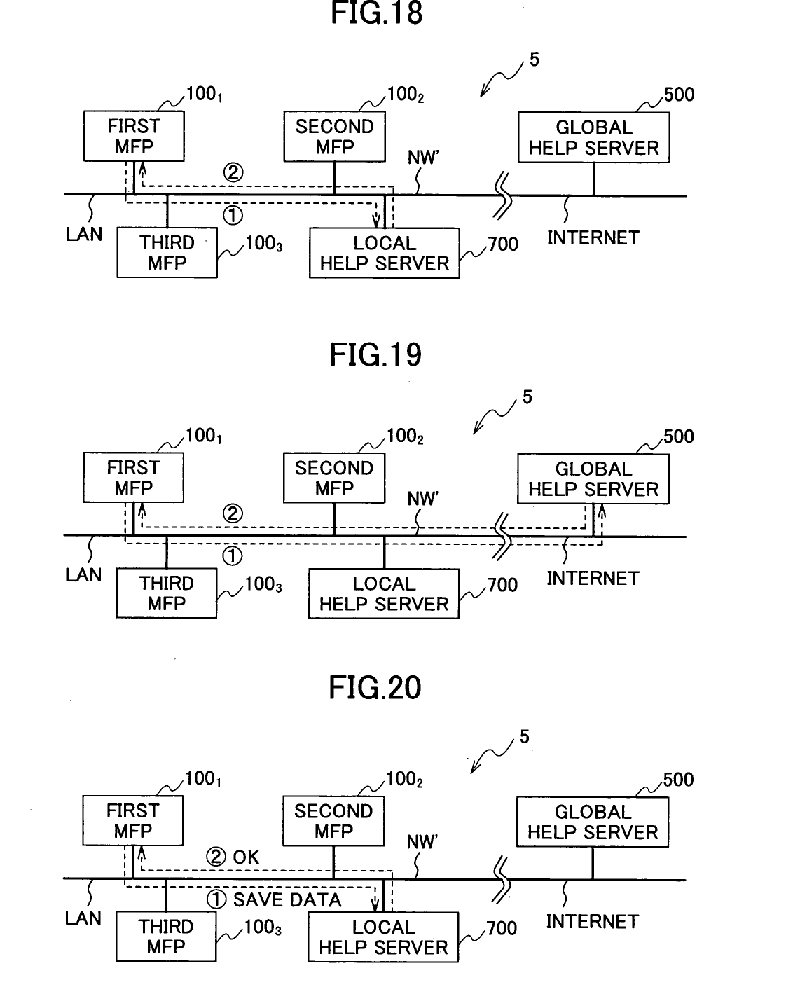

On the other hand, if the corresponding help data cannot be found in the local help server 700, the first MFP 100₁ may request the global help server 500 located over the Internet to send the corresponding help data (step 207 of FIG. 17). In turn, the corresponding help data may be received and displayed at the first MFP 100₁ (step 209 of FIG. 17) as is illustrated in FIG. 19.

Then, the first MFP 100₁ may request the local help server 700 to save and register the corresponding help data. When the registration is successfully completed, the first MFP 100₁ may delete the cache data stored therein (step 211 of FIG. 17) as is illustrated in FIG. 20.

According to this arrangement, help data that are once downloaded may be stored in the local help server 700 as cache data so that quick downloading of the help data may be realized from the second time and onward, and the cache area of each of the individual MFPs 100 may be reduced.

In the above description of the present embodiment, the cached help data are left untouched until the cache area runs out. However, the cached help data may be rewritten more promptly as described in the fourth embodiment. For example, a random time once a month may be set at the local help server 700, and at the set time, the local help server 700 may make an inquiry to the global help server 500 to compare its cached help data with the corresponding help data stored in the global help server 500. If it is determined that old cache data exist within the local help server 700 (if the corresponding help data stored in the global help server 500 are updated), the updated help data may be downloaded in order to keep the cache data in the local help server 700 up-to-date.

In such an arrangement, the cached help data may be automatically updated when a newer version of the corresponding help data comes out so that the help data cached in the local help server 700 may be maintained up-to-date. Also, since the downloading request for updated help data is made by the local help server 700 residing within the LAN, this operation may be realized even when a firewall is implemented.

Also, as with the previous embodiments, the help data are not limited to a particular language, nor are they limited to text data. For example, the help data may include moving image data in GIF format, or a moving image object represented using JAVA (registered trademark) applet. The help data may also include audio data in which case additional devices such as a speaker, an amp, an audio D/A converter may be implemented in the MFP 100, and compressed audio data may be stored as help data at the help servers 500 and 700.

In the present embodiment, a communication protocol for realizing communication between apparatuses residing within the LAN may be of any type. For example, a unique protocol may be used, or an existing protocol such as UpnP or JINI may be used.

Further, it is noted that the above detailed descriptions of the present invention correspond to illustrative embodiments, and the present invention is by no way limited to these embodiments; that is, many variations and modifications may be conceived without departing from the scope of the present invention.

The present application is based on and claims the benefit of the earlier filing date of Japanese Patent No. 2003-039080 filed on Feb. 18, 2003, and Japanese Patent No. 2003-149506 filed on May 27, 2003, the entire contents of which are hereby incorporated by reference.

What is claimed is:

1. An imaging apparatus help system comprising:
an imaging apparatus that is connected to a network and is adapted to output and record an image on paper, the imaging apparatus including an operation unit, a display unit, and an information memory unit; and
an information server that is connected to the network and is adapted to receive a communication information request from the imaging apparatus, the information server including an information storage unit storing a plurality of types of communication information, wherein
when a user request for a predetermined type of the types of communication information is made at the operation unit of the imaging apparatus, if the predetermined type of communication information is stored in the information memory unit of the imaging apparatus, the imaging apparatus reads the predetermined type of communication information from the information memory unit and displays the read communication information on the display unit, and if the predetermined type of communication information is not stored in the information memory unit of the imaging apparatus., the imaging apparatus sends a request for the predetermined type of communication information to the information server, and the information server reads the predetermined type of communication information from the information storage unit and sends the predetermined type of communication information to the imaging apparatus, and the imaging apparatus stores the predetermined type of communication in the information memory unit and displays the predetermined type of communication information on the display unit; and
the imaging apparatus stores in the information memory unit one or more of the types of communication information received from the information server, and deletes at least a portion of the stored one or more types of communication information when a remaining storage capacity of the information memory unit is reduced to no more than a predetermined capacity.

2. The imaging apparatus help system as claimed in claim 1, wherein the communication information corresponds to help information pertaining to operating the imaging apparatus.

3. The imaging apparatus help system as claimed in claim 1, wherein the deletion of the communication information is performed in chronological order according to a storage date of the communication information stored in the information memory unit.

4. The imaging apparatus help system as claimed in claim 1, wherein the deletion of the communication information is performed based on a usage frequency order of the communication information stored in the information memory unit.

5. The imaging apparatus help system as claimed in claim 1, wherein the deletion of the communication information is performed based on a data size of the communication information stored in the information memory unit.

6. The imaging apparatus help system as claimed in claim 1, wherein the communication information includes a program that is executable at the imaging apparatus.

7. The imaging apparatus help system as claimed in claim 6, wherein the program corresponds to a JAVA applet.

8. The imaging apparatus help system as claimed in claim 6, wherein the program corresponds to a mobile agent.

9. The imaging apparatus help system as claimed in claim 1, wherein each type of communication information is described in a plurality of formats, and a format is selected at the imaging apparatus for providing the predetermined type of communication information that is requested at the operation unit, the predetermined type of communication information in the selected format being read from the information memory unit and displayed if the predetermined type of communication information in the selected format is stored in the information memory unit, and a communication information request for the predetermined type of communication information in the selected format being made to the information server if the predetermined type of communication information in the selected format is not stored in the information memory unit, after which the predetermined type of communication information in the selected format from the information server is stored in the information memory unit and displayed on the display unit.

10. The imaging apparatus help system as claimed in claim 9, wherein the communication information in one format includes a program that is executable at the imaging apparatus.

11. The imaging apparatus help system as claimed in claim 9, wherein the communication information in one format includes switching a language in which the communication information is to be displayed.

12. An imaging apparatus help system comprising:
a plurality of imaging apparatuses and a help server that are connected to a network, wherein each of the imaging apparatuses and the help server has a storage unit for storing help data; and
help data operation means for realizing a help data operation when one of the imaging apparatuses connected to the network requires a predetermined type of help data, the help data operation being performed on at least one other device connected to the network.

13. The imaging apparatus help system as claimed in claim 12, wherein the help data operation includes at least one of reading, writing, and deleting predetermined help data.

14. An imaging apparatus help system comprising:
a plurality of imaging apparatuses and a help server that are connected to a network, wherein each of the imaging apparatuses and the help server has a storage unit for storing help data; and
inquiry means for making an inquiry about an availability of help data when one of the imaging apparatuses connected to the network requires a predetermined type of help data, the inquiry being made on at least one other device connected to the network.

15. The imaging apparatus help system as claimed in claim 14, wherein the device corresponds to another imaging apparatus connected to the network.

16. The imaging apparatus help system as claimed in claim 14, wherein the device corresponds to the help server.

17. The imaging apparatus help system as claimed in claim 14, wherein the help data includes a moving image object.

18. The imaging apparatus help system as claimed in claim 14, wherein the help data includes audio data.

19. An imaging apparatus help system comprising:
a plurality of imaging apparatuses and a help server that are connected to a network, wherein each of the imaging apparatuses and the help server has a storage unit for storing help data; and
comparing means for comparing the help data stored in one of the imaging apparatuses connected to the network and the help data stored in the help server; and
updating means for updating the help data stored in said one imaging apparatus when it is determined by the comparison means that the help data stored in said one imaging apparatus are old, the updating being realized by downloading the help data stored in the help server to said one imaging apparatus.

20. An imaging apparatus help system comprising:
a plurality of imaging apparatuses and a plurality of help servers that are connected to a network, wherein each of the help servers has a storage unit for storing help data that are to be provided to the imaging apparatuses; and
comparing means for comparing help data stored in the respective help servers; and
updating means for updating help data when it is determined by the comparing means that the help data stored in one of the help servers are old, the updating being realized by downloading to said one help server the help data stored in another one of the help servers storing new help data.

21. A method of providing help information to an imaging apparatus that is connected to a help server via a network, wherein the help server has a storage unit storing a plurality of types of help information, and the imaging apparatus has a memory unit for storing one or more of the types of help information received from the help server, the method comprising:
searching for a predetermined type of the types of help information in the memory unit of the imaging apparatus;
requesting the help server to send the predetermined type of help information to the imaging apparatus when the predetermined type of help information is not found in the searching step;
sending the predetermined type of help information from the help server to the imaging apparatus and storing the predetermined type of help information in the memory unit; and
deleting at least a portion of the one or more types of help information stored in the memory unit according to a predetermined rule when a remaining storage capacity of the memory unit is reduced to no more than a predetermined capacity.

22. A method of providing help data to an imaging apparatus that is connected to at least one other imaging apparatus and a help server via a network, wherein the imaging apparatus, the other imaging apparatus and the help server each have a storage unit for storing one or more types of help data, the method comprising:
making an inquiry about an availability of a predetermined type of help data to the other imaging apparatus; and
if the predetermined type of help data is available at the other imaging apparatus, reading and sending the predetermined type of help data from the other imaging apparatus to the imaging apparatus, and storing the predetermined type of help data in the imaging apparatus.

23. The method as claimed in claim 22, further comprising:
comparing the help data stored in the imaging apparatus and the help data stored in the help server; and
updating the help data stored in the imaging apparatus when it is determined in the comparing step that the help data stored in the imaging apparatus are old, the updating being realized by downloading to the imaging apparatus the help data stored in the help server corresponding to new help data.

24. A method of providing help data to an imaging apparatus that is connected to a local help server, and a global help server via a network, wherein the imaging apparatus, the local help server, and the global help server each have a storage unit for storing one or more types of help data, the method comprising:
making an inquiry about an availability of a predetermined type of help data to the local help server; and
if the predetermined type of help data is available at the local help server, reading and sending the predetermined type of help data from the local help server to the imaging apparatus, and storing the predetermined type of help data in the imaging apparatus.

25. The method as claimed in claim 24, further comprising:
comparing the help data stored in the local help server and the help data stored in the global help server; and
updating the help data stored in the local help server when it is determined in the comparing step that the help data stored in the local help server are old, the updating being realized by downloading to the local help server the help data stored in the global help server corresponding to new help data.

27. An imaging apparatus for use in an imaging apparatus help system, which help system includes an information server connected to the imaging apparatus via a network, the information server including an information storage unit for storing a plurality of types of communication information, and being adapted to receive a communication information request from the imaging apparatus, the imaging apparatus comprising:
an operation unit for making a user request for a predetermined type of the types of communication information;
a display unit for displaying the requested communication information; and
a memory unit for storing one or more of the types of communication information; wherein
if the predetermined type of communication information is stored in the memory unit, the imaging apparatus reads the predetermined type of communication information from the memory unit and displays the read communication information on the display; and
if the predetermined type of communication information is not stored in the memory unit, the imaging apparatus makes a communication information request for the predetermined type of communication information to the information server, and the information server reads the predetermined type of communication information from the storage unit and sends the predetermined type of communication information to the imaging apparatus, and the imaging apparatus stores the predetermined type of communication information in the memory unit and displays the predetermined type of communication information on the display unit; and
the imaging apparatus deletes at least a portion of the one or more types of communication information stored in the memory unit when a remaining storage capacity of the memory unit is reduced to no more than a predetermined capacity.
